(19) United States
(12) Patent Application Publication
(10) Pub. No.: US 2008/0166058 A1
(43) Pub. Date: Jul. 10, 2008

(54) Apparatus and method for transmitting and receiving image data in communication system

(75) Inventor: Seong-Gu Kim, Seoul (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/006,724

(22) Filed: Jan. 4, 2008

(30) Foreign Application Priority Data
Jan. 4, 2007 (KR) 2007-0000998

(51) Int. Cl. G06K 9/36

(52) U.S. Cl. 382/232

(57) ABSTRACT

An apparatus and method for transmitting and receiving an image in a communication system are provided. The apparatus includes an identifying unit, an extractor, and a communication unit. The identifying unit identifies information on a display size of a reception stage. The extractor extracts from image data as much image data as a size corresponding to the display size and inserts information on a size of whole image data into the extracted image data. The communication unit transmits the extracted image data.

### CROSS-REFERENCE TO RELATED APPLICATION(S) AND CLAIM OF PRIORITY

This application claims priority under 35 U.S.C. §119(a) to a Korean Patent Application filed in the Korean Intellectual Property Office on Jan. 4, 2007 and assigned Serial No. 2007-0000998, the contents of which are herein incorporated by reference.

### TECHNICAL FIELD OF THE INVENTION

The present invention relates generally to an apparatus and method for transmitting and receiving image data in a communication system, and in particular, to an apparatus and method for adjusting a size of image data according to a display size of a reception stage in a communication system.

### BACKGROUND OF THE INVENTION

In order for a communication system to restore an image transmitted from a transmission stage, a reception stage has to receive whole image data. For example, in the case of image data with a size of 500 KB, a failure of receiving the whole 500 KB in the reception stage leads to an error during restoration and thus users cannot identify a complete image.

If the communication system is a wireless communication system, the transmission stage and the reception stage communicate with each other using limited radio resources. Image data with a large size occupies relatively more radio resources compared to voice data and thus, reduces a chance of transmission and reception of other data. With a larger size of image data, users should wait to complete reception of the image data for a longer time. Here, a large size of image data has the same meaning as an excellent quality of image.

However, the reception stage receiving image data can use a diversity of display devices but is not provided with the ability to express a large-size image data, that is, a high-definition image. In this case, when a large-sized, high-definition image is transmitted from the transmission stage, large-sized image data leads to unnecessary consumption of traffic. Accordingly, there is a need for a solution for adjusting a size of image data transmitted according to the characteristics of the display device of the reception stage.

### SUMMARY OF THE INVENTION

To address the above-discussed deficiencies of the prior art, it is a primary aspect of the present invention to substantially solve at least the above problems and/or disadvantages and to provide at least the advantages below. Accordingly, one aspect of the present invention is to provide an apparatus and method for reducing an amount of traffic consumed to transmit and receive image data in a communication system.

One aspect of the invention provides an apparatus and method for adjusting a size of image data according to display characteristics of a reception stage in a communication system.

Another aspect of the invention provides an apparatus and method for extracting part of image data compressed using a wavelet transform and restoring the extracted image data in a communication system.

The above aspects are achieved by providing an apparatus and method for transmitting and receiving image data in a communication system.

In one aspect of the present invention, there is provided an apparatus for transmitting an image in a communication system. The apparatus includes an identifying unit, an extractor, and a communication unit. The identifying unit identifies information on a display size of a reception stage. The extractor extracts image data of a size corresponding to the display size and inserts size information of whole image data into the extracted image data. The communication unit transmits the extracted image data.

According to another aspect of the present invention, there is provided an apparatus for receiving an image in a communication system. The apparatus includes a restoring unit and a display unit. The restoring unit identifies a size of whole image data, which is included in received image data, and reconstructs the received image data as image data of the same size as the size of the whole image data by inserting one or more null values into the received image data. The display unit displays the reconstructed image data.

According to a further aspect of the present invention, there is provided a method for transmitting an image in a communication system. The method includes identifying a display size of a reception stage; extracting image data of a size corresponding to the display size; inserting information on a size of whole image data into the extracted data; and transmitting the extracted data.

According still another aspect of the present invention, there is provided a method for receiving an image in a communication system. The method includes identifying a size of whole image data, which is included in the received image data; reconstructing the received image data into image data of the same size as the size of the whole image data by inserting one or more null values into the received image data; and displaying the reconstructed image data.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates restoration characteristics of image data compressed using a wavelet transform;

FIG. 2 is a block diagram illustrating a transmission stage in a communication system according to the present invention;

FIG. 3 is a block diagram illustrating a reception stage in a communication system according to the present invention;

FIG. 4 is a flow diagram illustrating a process of transmitting, by a transmission stage, image data in a communication system according to an exemplary embodiment of the present invention; and

FIG. 5 is a flow diagram illustrating a process of receiving, by a reception stage, image data in a communication system according to an exemplary embodiment of the present invention.

### DETAILED DESCRIPTION OF THE INVENTION

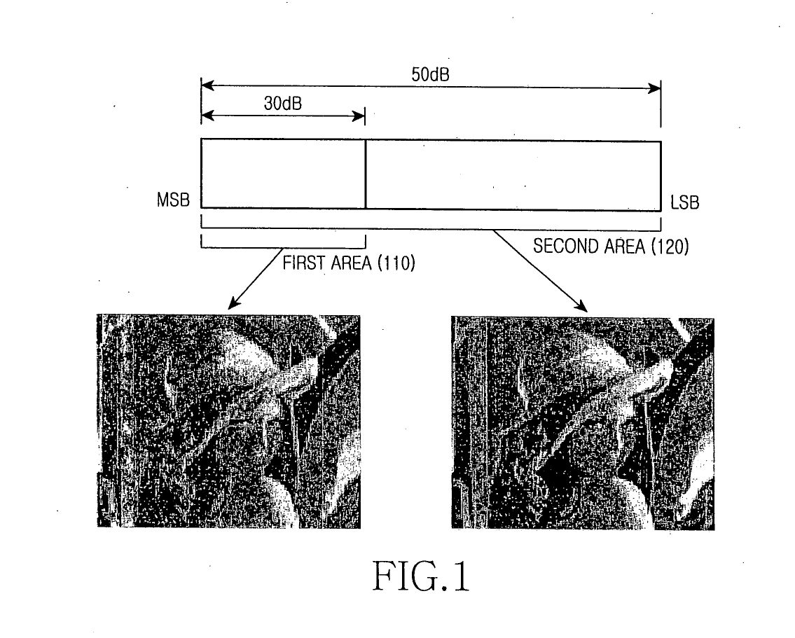

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged image data processing system.

In the present invention, a technology for adjusting a size of image data for transmission according to a display size of a reception stage and receiving and restoring image data of a reduced size in a communication system is described below. In the present invention, image data of a Joint Photographic coding Experts Group (JPEG) 2000 format is described below, for example. Any image data compressed using a wavelet transform is applicable identically.

First, a description of the characteristics of image data compressed using a wavelet transform such as a JPEG 2000 format is made.

Information of significance includes a front portion of the whole of image data compressed using the wavelet transform. This makes it possible to restore a JPEG 2000 image compressed using the wavelet transform to the original state though data of a rear portion is lost by half or more. Undoubtedly, an image restored with data partly lost is of a relatively low quality compared to an image restored with whole data without loss.

For instance, as in FIG. 1, image restoration can be achieved even with only a first area 110 that is a partial extraction of image data. In detail, in cases where only the first area 110 with peak signal to noise ratio (PSNR) of 30 dB is extracted, the image is of a lower quality than that of a second area 120 with PSNR of 50 dB, that is, whole data; however, the image is restored to a recognizable level.

A description of construction and operation of a transmission stage and a reception stage for adjusting a size of image data using a wavelet transform technology and transmitting and receiving the image data according to the present invention are made in detail below with reference to the accompanying drawings.

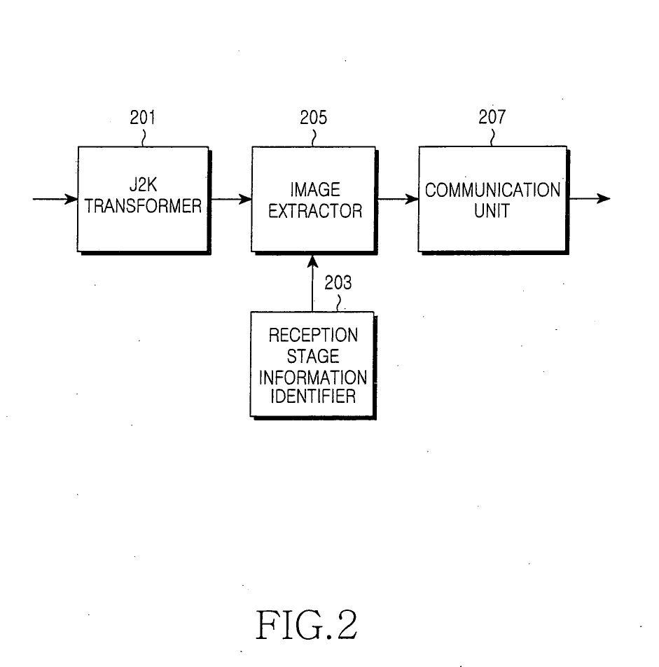

FIG. 2 is a block diagram illustrating a transmission stage in a communication system according to the present invention.

Referring to FIG. 2, the transmission stage includes a JPEG 2000 (hereinafter, referred to as “J2K”) transformer 201, a reception stage information identifier 203, an image extractor 205, and a communication unit 207.

The J2K transformer 201 checks whether image data to be transmitted is of a J2K format. If the image is not of the J2K format, the J2K transformer 201 transforms the format of the image data into the J2K format and outputs the image data to the image extractor 205. If the image data is of the J2K format, the J2K transformer 201 passes the image data to the image extractor 205.

The reception stage information identifier 203 identifies a display size of a reception stage. The display size information is stored in a storage unit (not shown) to store information on the reception stage. Alternatively, according to cases, the reception stage information identifier 203 can receive and identify the reception stage information from a source external. In cases where the storage unit is provided to store the display size information on the reception stage, the storage unit registers and holds the display size information on the reception stage when the reception stage connects to a communication network.

The image extractor 205 receives J2K image data from the J2K transformer 201, receives the display size information on the reception stage from the reception stage information identifier 203, and reduces a size of the image data to a size corresponding to a display size, that is, extracts from whole image data as much upper bit stream data as the size corresponding to the display size. At this time, the image extractor 205 inserts the size information of the whole image data into the extracted image data so that the reception stage can be aware of the size of the whole image data.

The communication unit 207 receives the extracted image data from the image extractor 205, converts the image data into a signal in compliance with an associated standard, and transmits the signal to the reception stage. If the transmission stage is a base station of a wireless communication system, the communication unit 207 includes an encoder, a modulator, a Radio Frequency (RF) processor, an antenna, etc. that are not shown.

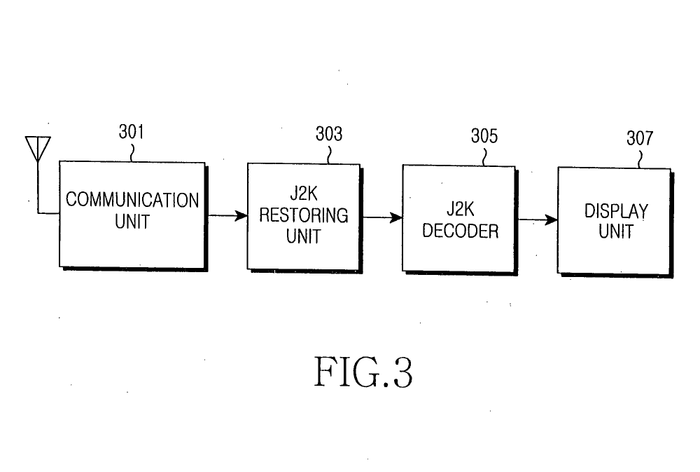

FIG. 3 is a block diagram illustrating a reception stage in a communication system according to the present invention.

As shown in FIG. 3, the reception stage includes a communication unit 301, a J2K restoring unit 303, a J2K decoder 305, and a display unit 307.

The communication unit 301 converts a signal received from a transmission stage into image data in compliance with an associated standard. If the reception stage is a terminal of a wireless communication system, the communication unit 301 includes an antenna, an RF processor, a demodulator, and a decoder, etc. that are not shown.

The J2K restoring unit 303 receives J2K image data from the communication unit 301 and identifies a size of the whole image data, the size information that is included in the image data. After identifying the size of the whole image data, the J2K restoring unit 303 inserts one or more null values into the received image data and restores the image data to the same size as the size of the whole image data. In other words, the J2K restoring unit 303 reconstructs the received image data in the same format as that of image data only part of which may be received because of an error during reception.

The J2K decoder 305 receives J2K image data from the J2K restoring unit 303, decodes or decompresses the received image data, and converts the image data into an analog signal. The display unit 307 receives the image data in analog signal from the J2K decoder 305 and displays the analog signal for user's viewing.

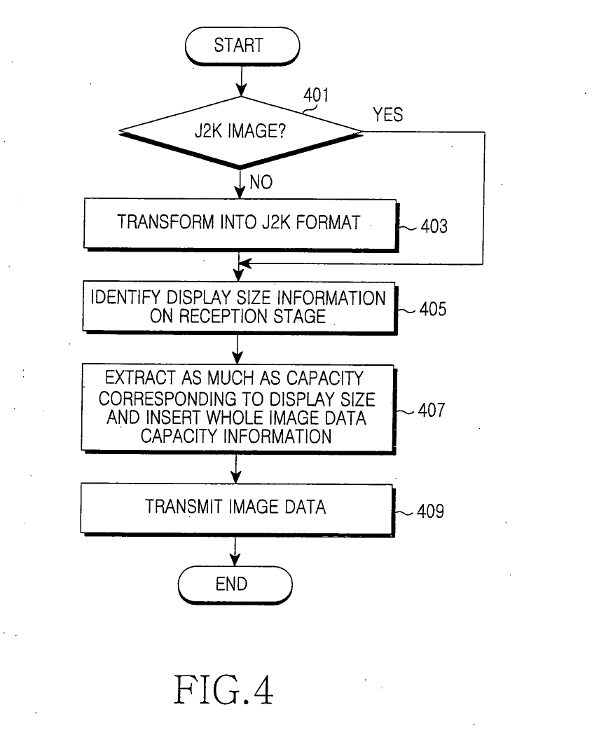

FIG. 4 is a flow diagram illustrating a process of transmitting, by a transmission stage, image data in a communication system according to an exemplary embodiment of the present invention.

Referring to FIG. 4, the transmission stage identifies whether an image to be transmitted to a reception stage is image data of a J2K format in step 401.

If the image is not of the J2K format, the transmission stage transforms the image into the J2K format in step 403.

If the image is of the J2K format, the transmission stage identifies a display size of the reception stage in step 405. The display size information can be identified with reference to information stored in the transmission stage or can be provided from an external device. If the display size information is the information stored in the transmission stage, the display size information is provided through a registration process when the transmitting stage enters a communication network.

After identifying the display size information, in step 407, the transmission stage extracts the J2K image data of a size corresponding to the identified display size and inserts information on a size of whole image data into the extracted image data. The extracted image data is upper bit stream data among the whole image data.

After that, the transmission stage transmits the extracted image data to the reception stage in step 409.

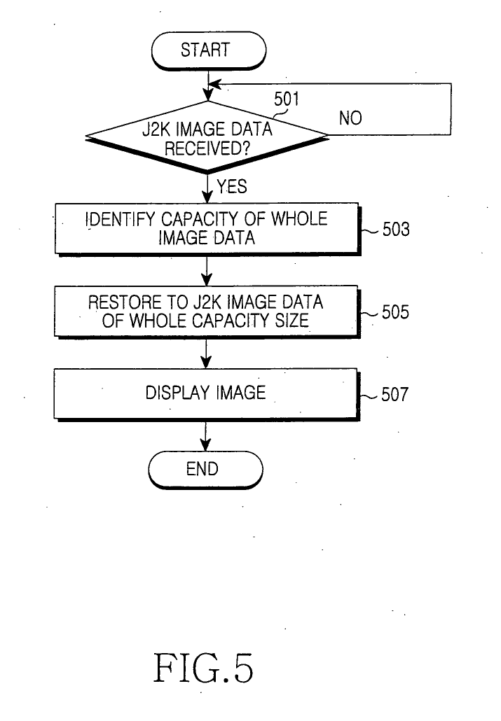

FIG. 5 is a flow diagram illustrating a process of receiving, by a reception stage, image data in a communication system according to an exemplary embodiment of the present invention.

Referring to FIG. 5, the reception stage identifies whether it receives J2K image data in step 501.

If receiving the J2K image data, the reception stage identifies a whole size of the received image data in step 503.

After identifying the whole size information, the reception stage inserts one or more null values into the received image data and restores the image data to image data of the same size as that of the whole size. In other words, the reception stage reconstructs the received image data in the same format as that of image data only part of which is received because of an error during reception.

Next, the reception stage displays the restored J2K image data in step 507.

As described above, the present invention can reduce an amount of traffic consumed by image data by adjusting a size of an image according to a display size of a reception stage for transmission and reception in a communication system. Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for transmitting an image in a communication system, the apparatus comprising:
an identifying unit for identifying a display size of a reception stage;
an extractor for extracting image data according to the display size and inserting a size information of whole image data into the extracted image data; and
a communication unit for transmitting the extracted image data.

2. The apparatus of claim 1, wherein the image data is compressed using a wavelet transform.

3. The apparatus of claim 2, wherein the image data is of a Joint Photographic coding Experts Group (JPEG) 2000 (J2K) format.

4. The apparatus of claim 3, further comprising: a transformer for identifying whether the image data is of the J2K format, transforming a format of the image data into the J2K format if the image data is not of the J2K format, and providing the image data to the extractor.

5. The apparatus of claim 1, further comprising: a storage unit for, when the reception stage enters a communication network, identifying display information the reception stage and storing the display information.

6. The apparatus of claim 1, wherein the extractor extracts upper bit stream data according to the size of the image data.

7. An apparatus for receiving an image in a communication system, the apparatus comprising:
a restoring unit for identifying a size of whole image data, which is included in received image data, and reconstructing the received image data into second image data of the same size as the whole image data by inserting one or more null values into the received image data; and
a display unit for displaying the reconstructed second image data.

8. The apparatus of claim 7, wherein the image data is compressed using a wavelet transform.

9. The apparatus of claim 8, wherein the image data is of a Joint Photographic coding Experts Group (JPEG) 2000 (J2K) format.

10. The apparatus of claim 9, further comprising: a decoder for decoding the J2K image data.

11. A method for transmitting an image in a communication system, the method comprising:
identifying a display size of a reception stage;
extracting image data according to the display size;
inserting a size of whole image data into the extracted image data; and
transmitting the extracted image data.

12. The method of claim 11, wherein the image data is compressed using a wavelet transform.

13. The method of claim 12, wherein the image data is of a Joint Photographic coding Experts Group (JPEG) 2000 (J2K) format.

14. The method of claim 13, further comprising:
identifying whether the image data is of the J2K format; and
transforming the image data into the J2K format if the image data is not of the J2K format.

15. The method of claim 11, wherein the display size of the reception stage is identified through a second display size that is registered when the reception stage enters a communication network.

16. The method of claim 11, wherein the extracted image data correspond to an upper bit stream among the image data.

17. A method for receiving an image in a communication system, the method comprising:
identifying a size of whole image data, which is included in received image data;
reconstructing the received image data into second image data of the size of the whole image data by inserting one or more null values into the received image data; and
displaying the reconstructed second image data.

18. The method of claim 17, wherein the image data is compressed using a wavelet transform.

19. The method of claim 18, wherein the image data is of a Joint Photographic coding Experts Group (JPEG) 2000 format.
